(19) United States
(12) Patent Application Publication
(10) Pub. No.: US 2011/0197143 A1
(43) Pub. Date: Aug. 11, 2011

(54) Virtual World Location Display Sorting

(76) Inventor: David Baszucki, Portola Valley, CA (US)

(21) Appl. No.: 12/701,214

(22) Filed: Feb. 5, 2010

(51) Int. Cl. G06F 3/01

(52) U.S. Cl. 715/745

(57) ABSTRACT

A method for presenting prioritized navigation links in an interactive display presented by an enterprise hosting a web site including places as destinations of the navigation links has steps for (a) identifying a person interacting with the interactive display, which is presented by software executing on a computerized appliance from a machine-readable medium; (b) determining characteristics of the person's interactive behavior with the web site; (c) determining characteristics of the places; (d) comparing the characteristics of the places with the characteristics of the person's interactive behavior to determine a likely preference for places to the person; and (d) presenting the navigation links in a descending order of preference in the interactive display to the person accessing the interactive display.

### BACKGROUND OF THE INVENTION

1. Field of the Invention

The present invention is in the field of virtual reality (VR) systems including on-line VR games, and pertains more particularly to optimization of user interaction with online virtual world (VW) systems.

2. Discussion of the State of the Art

In the art of computer-aided modeling, virtual reality (VR) environments are created and exist for such as educational and entertainment purposes. VR games, three dimensional toys, and other types of virtual environments exist where clients subscribe to a gaming site or virtual-world site and engage in interaction with the virtual presentations, typically through a character representing the client/user, that character termed in the art an Avatar. In some cases several different sorts of VR activity may be integrated in a single site; that is, VR games, toys, social interaction, and the like, may all be accessed through a common site. One such site may be experienced at ROBLOX.com, for example, which is a system providing an Internet Website wherein registered users may design and upload their own virtual game, or “Place” and interact with other online users in other virtual Places. The term “Place” is art terminology for destinations on such a site for such as virtual games or activities. In the following description of embodiments of the present invention, the term “Place” and “game” may be used interchangeably. In a system such as that provided by ROBLOX.com, multiple virtual Places, which may be created by registered users of the system are offered, and the virtual Places may be online mini-games or can be coordinates/locations within a larger virtual world.

At a VR site such as ROBLOX, users are enabled to register, thereby creating a user account, and then may enter the site via log-in by entering a username and a password. At any point in real time there may be a relatively large number of users logged in and participating in activities through functionality of the site. Administrative functions track each registered user while engaged until the user logs out, and other functions serve to enhance the user's experience and to store use history, associated both with users and with places. Registered user online activities, characteristics and behavior is tracked and stored by the system, and such information desirably tracked by the system may include such as length of first-time play, online interaction with other users of the system, percentage of new users committing to various additional services offered by the system, and so on. Statistics and data regarding users are also tracked and stored associated with games and other places.

Due to the emergence of online gaming as a popular and successful form of education, entertainment and play for people of all ages, many online users devote a considerable amount of time to such activity, and may be a registered and regular long-time user of a particular VR site. Many such regular users have become adept at skills and techniques required for successes in their favorite VR games, and there are also those users who may be new to online gaming as a whole, or new to a particular gaming site and the particular games offered by that site. Many such new users are particularly interested in the games popular with other new users, as well as the early game-playing successes of, and post-play ratings by the other new users.

In state-of-the-art online VR systems, online gaming and other online activity for all registered users of a VR site is tracked and the resulting data is gathered, stored and associated with for instance, particular VR games offered by the site. Such information may include game use and rating information, and may be displayed along with game representations to a user browsing games, and the browsing user may sort the display according to the information criteria. However, for a new user wishing to browse through only those games that are popular with other new users, along with information pertaining to the game's use, successes and ratings by other new users, the task is difficult and cumbersome at best. Additionally, online game system administrators are interested in the popularity of online games or “Places” offered by the system, particularly for new users, whether the Places are established or “experimental trial” Places. That is for instance, which Places are most-often visited, length of time spent in the Places, post-play ratings, game-playing successes and other new-user online activities. In order to attract and retain potential patrons of services offered by such an online gaming system, it is desirable to offer new users browsing the gaming Website, an optimized view of available virtual Places in the virtual world of the system, such a view tailored to the new user. It is also important to the administrators of such a system to gather new-user activity and characteristics information associated with particular Places that are popular with other new users, as well as at the same time, gather such new user information associated with “experimental trial” Places. The information gathered need not be limited to new users, because the parameters for sorting can be very broad, and existing users may be included. Places might also be sorted by other parameters to optimize the interest of users, such as games sorted to maximize fun and excitement for the users.

Therefore, what is clearly needed is a proactive and user-friendly way to interactively enable new users of an online gaming site to quickly and easily browse virtual Places popular with other new users, and view information pertaining to the Places' use, successes and ratings by other registered new users. What is also needed is a system for gathering new-user activity and characteristics information associated with particular Places that are popular with other new users, as well as gathering and storing such new user information associated with “experimental trial” virtual Places. Such a system would substantially increase new user activity and interest in VR products offered by the virtual world site, and serve to retain such users for future patronization.

### SUMMARY OF THE INVENTION

The inventor has recognized a need for presenting interactive links to places in a web site in a manner that a person interacting with the web site will navigate with high probability to places in the web site that will provide a satisfactory experience for the person. The inventor has also recognized that this need may be met by a consideration both of preferences and behavior of the person interacting and characteristics of the places, including preferences for the places by other persons interacting with the web site. Accordingly the inventor has invented a method for presenting prioritized navigation links in an interactive display presented by an enterprise hosting a web site including places as destinations of the navigation links, comprising the steps of (a) identifying a person interacting with the interactive display, which is presented by software executing on a computerized appliance from a machine-readable medium; (b) determining characteristics of the person's interactive behavior with the web site; (c) determining characteristics of the places; (d) comparing the characteristics of the places with the characteristics of the person's interactive behavior to determine a likely preference for places to the person; and (e) presenting the navigation links in a descending order of preference in the interactive display to the person accessing the interactive display.

In one embodiment of the method the characteristics of the person's interactive behavior with the web site include stored data indicating length of time the person has been registered to the web site. Also in one embodiment the characteristics of places includes at least stored data regarding statistics of visits to the places by other registered members. In some embodiments the statistics of visits include one or more of frequency of visits, total number of visits, and time spent per visit. Further, the characteristics of the person's interactive behavior with the web site may include data provided by the person in a stored profile, the data including preference for place characteristics. In a preferred embodiment the web site is a virtual reality web site, and the places are virtual reality games.

In another aspect of the invention a web site is provided, comprising software executing on a computerized appliance from a machine-readable medium, providing an interactive display; and navigation links presented in the interactive display in a prioritized arrangement, the links to places in the web site. The software identifies a person interacting with the interactive display, determines characteristics of the person's interactive behavior with the web site, determines characteristics of the places, compares the characteristics of the places with the characteristics of the person's interactive behavior, determines a likely preference for places to the person, and presents the navigation links in the prioritized arrangement as a descending order of preference in the interactive display to the person accessing the interactive display.

In one embodiment of the web site the characteristics of the person's interactive behavior with the web site include stored data indicating length of time the person has been registered to the web site. Also in one embodiment the characteristics of places includes at least stored data regarding statistics of visits to the places by other registered members. In some embodiments the statistics of visits include one or more of frequency of visits, total number of visits, and time spent per visit. Characteristics of the person's interactive behavior with the web site may include data provided by the person in a stored profile, the data including preference for place characteristics. In a preferred embodiment the web site is a virtual reality web site, and the places are virtual reality games.

### BRIEF DESCRIPTION OF THE DRAWING FIGURES

FIG. 1 is an architectural overview of a communications network supporting user participation in a web-based Virtual Reality site in an embodiment of the present invention.

FIG. 2 is an illustration of a virtual reality Website game page according to prior art.

FIG. 3 is an illustration of a virtual reality Website game page according to an embodiment of the present invention.

### DETAILED DESCRIPTION

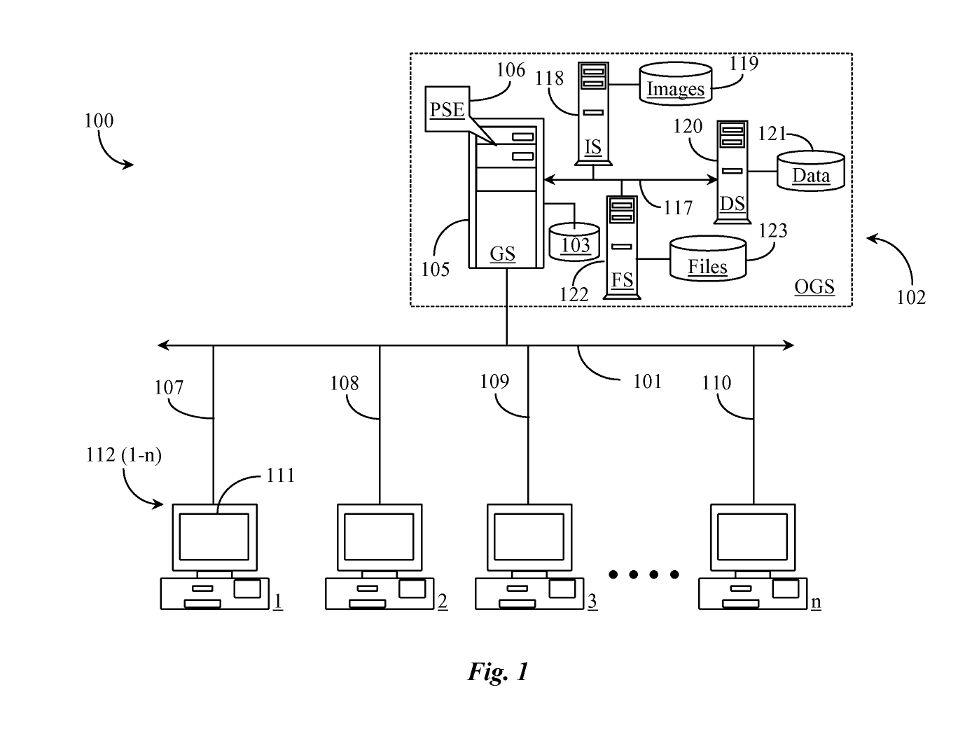

FIG. 1 is an architectural overview of a communications network 100 supporting user participation in a web-based Virtual Reality (VR) site in an embodiment of the present invention. Communications network 100 represents a digital wide-area-network (WAN) such as an Internet network. A network backbone 101 is illustrated in this example and represents all of the lines, equipment, and access points that make up the Internet network as a whole. Therefore, there are no geographic limitations to the practice of the present invention. Network 100 may include the Internet network and any connected sub-networks including telephone carriers that may provide access to network 100 physically represented herein by backbone 101.

In this example, network backbone 101 serves as a carrier network for communications between an online gaming service (OGS) 102 and multiple clients 112 (1−n) of OGS 102. OGS 102 represents any enterprise adapted to provide an online virtual environment (VE), including such as virtual worlds and online VR games. Such virtual worlds and online games may be accessed by subscribing clients operating client computing devices 112 (1−n) having Internet access through any of the several known ways that Internet access may be attained.

Site 102 comprises a server or set of servers 105 including a digital medium 103 coupled thereto which is adapted to store all of the software and data required to enable server function as a Web server capable of serving electronic information pages to clients of site 102, and of registering clients for access to virtual environments and or online gaming available through OGS 102. The software for all of this functional activity executes on server 105 from machine-readable digital medium 103. Client computing devices 112 (1−n) are desktop personal computers (PCs) in this example, but may in alternative examples be a mix of personal computers, hand-held digital appliances such as cellular telephones, personal digital assistants (PDAs), or any sort of computing appliance capable of Internet access. In this example, client computing devices 112 (1−n) are connected to network backbone 101 via logical access line connections 107, 108, 109, and 110. It is noted herein that client computing devices 112 (1−n) may connect to network backbone 101 through an Internet Service Provider (ISP) using a high-speed Internet access protocol like digital services line (DSL), broadband, T1-X, wireless (WiFi), cable/modem, and in other ways as well.

Each client device 112 (1−n) includes at least one central processing unit (CPU) coupled thereto and adapted to execute all of the software and data required to enable multi-task or dedicated computing function. Each client device 112 (1−n) includes a browser application 111 enabling access to pages served by server 105. Server 105 comprises, among other server components, a physics simulation engine (PSE) 106. PSE 106 provides real-time physics simulation of 3D objects of a virtual environment. In one embodiment PSE 106 is a rigid-body-dynamics simulation engine although other types and combinations thereof might be used in practice of the present invention.

In this example client computing devices 112 (1−n) are connected online over network backbone 101 with site 105 and are actively engaged in a VE offered through the server, such as an online virtual game, or are otherwise interacting in the virtual world.

Server 105 has in this particular embodiment a separate digital network connection 117 to various support servers and data repositories adapted to facilitate project and game service delivery. An image server (IS) 118 is provided within site 102 and is connected to server 105 via network 117. IS 118 has a digital medium 119 coupled thereto. Digital medium 119 is an image repository adapted to store all of the software and data required to enable server function as an image server. IS 118 is adapted primarily to serve VR images to GS 105 from digital medium 119. Digital medium 119 may be a mechanical disk drive, a magnetic disk or an optical disk, or other known data repository without departing from the spirit and scope of the present invention.

A file server (FS) 122 is provided within site 102 and is connected to server 105 via network 117. FS 122 has a digital medium 123 coupled thereto. Digital medium 123 is a file repository adapted to store all of the software and data required to enable server function as a file server. FS 122 is adapted to serve files representing online virtual environments including virtual worlds, virtual games, etc. to server 105 for rendering. FS 122 manages games or files on digital medium 123, which may be a mechanical disk drive, a magnetic disk or an optical disk, or other known data repository without departing from the spirit and scope of the present invention.

A data server (DS) 120 is provided within site 102 and is connected to server 105 via network 117. DS 120 has a digital medium 121 coupled thereto which is adapted to store all of the software and data required to enable server function as a data server. DS 120 is adapted to serve run-time data relative to any virtual environments being rendered by server 105. Data may include any technical data and information required to successfully render a VR in real time.

In practice of the invention, assume a number of clients 112 (1−n) are connected to server 105 and many are participating in interaction with a virtual environment running on the server, which may be a virtual game. One service provided by server 105 is enabling subscribing users to browse online games offered by the gaming service, and the user may select categories of criteria associated with the games, whereby the user is presented with a “games” page showing representations of games offered by the service, sorted according to the criteria selected, and information associated with each game is displayed along with the game representation. Another service provided is that users may click on a selected game representation and actively engage in that particular game with at least one additional online player, as is widely known in online gaming technology.

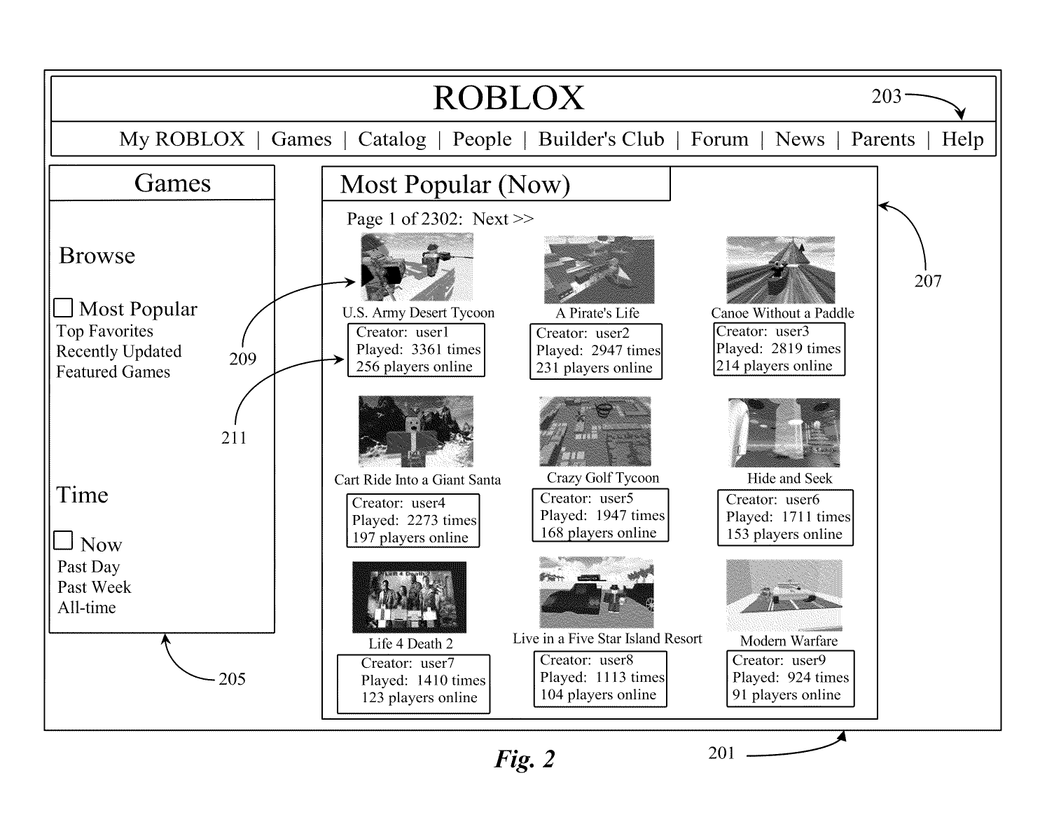

FIG. 2 is an illustration of a virtual reality Website game page 201 served by server 105 of FIG. 1 accessed by a user of one of client stations 112 (1−n) enabled by browser application 111. Game page 201 is an example of a gaming Website display which, if a subscribing client is logged in to the Website, might display game representations and other objects from which the client may select as shown minimally in FIG. 2 in the games page. Game representations and other selectable objects will typically be dynamic and displayed dependent, at least to some extent, on input by the client through an input device.

In game page 201 presented by server 105 there will typically be, as is common in web pages, a variety of links through either or both of text and graphical images, for the client to use to navigate to other pages and portions of the overall web presentation. A row of interactive tabs are shown in game page 201 along the upper edge of the display. Tab bar 203 comprises several interactive tabs, each tab being a link to another page or section of the overall web experience. For example, by the registered and logged-on client selecting the “My Roblox” tab the client will be taken to a page where the client can customize his or her own character, or Avatar, access and edit personal information (user profile), view account settings, view messages from game service administrators or other registered users, and so on. The tab “Catalog” takes the client to a page or pages where different services or products may be browsed that are available for purchase or use. The tab “News” takes the client to a page or pages where for example the latest developments for the enterprise are presented for the client to browse.

A display area 207 comprises a plurality of links 209 which are URL links to online virtual Places maintained by the service, and by selecting a link 209 the client is enabled to actively engage in interaction with the online Place represented by the selected link. Links 209 are exemplarily illustrated as graphical representations in FIG. 2, but may be textual in other embodiments. Below each link 209 the title of the represented Place is displayed, and below the Place title is a display area 211. Display area 211 has the purpose of displaying real-time or historical information pertaining to its associated Place, including but not limited to authoring and update information, number of times played by registered users, number of registered users currently online and actively engaged in playing the game, number of games sold to registered users, post-play game rating by registered users, and so on. The above examples of information displayed in areas 211 may vary in different embodiments as will be further detailed below.

Game page 201 comprises a display area 205 which in this example is located to the left of display area 207. Display area 205 has a plurality of interactive menu items from which a browsing client may choose to determine which Places are displayed in display area 207. In the example of FIG. 2, two menu areas are shown, the upper menu area entitled “Browse” and the lower menu area entitled “Time”. The “Browse” menu area in this example comprises user-selectable textual links from which the user may click to determine the Places displayed in area 207 according to the criteria of “Most Popular”, “Top Favorites”, “Recently Updated” or “Featured Games”. The “Time” menu area comprises user-selectable textual links from which the user may click to determine the Places displayed in area 207 according to the criteria of “Past Day”, “Past Week” or All-time”. In other embodiments other criteria categories may be offered in area display area 207 such as “Genre” comprising selectable links such as sci-fi, horror, sports, military, and so on. There are many possibilities.

In the example given, assume an Internet user has entered the ROBLOX.com URL in a browser application and thereby directed to a login Webpage. The user visiting the login page (not shown) may login with username/password if pre-registered, and if not already registered, is given the opportunity to do so in order to create a new user account. Whether the user is registered or not, a tab bar similar to tab bar 203 is presented in the login page, and the user in this example has selected the “Games” tab to browse games (Places). Games page 201 is thereby displayed in the user's browser application. The user has selected “Most Popular” (highlighted) in the Browse section of display 205, and has selected “Now” (highlighted) in the Time portion of display area 205. The combination of the Browse and Time criteria selection “Most Popular (Now)” and “page 1 of 2302” is caused to display in area 207, which displays page 1 comprising nine game links 209 each with their respective display areas 211. In this example the upper-left game link 209 entitled “U.S. Army Desert Tycoon” has a display area 211 showing the Place creator, number of times played, and number of players currently online and interacting with the Place (playing the game). To the right of the “U.S. Army Desert Tycoon” link 209 is the next link 209 entitled “A Pirate's Life” and its respective display 211 showing the same Place-associated information, but at lesser values. In this example representations of the remaining seven Places are displayed along with their respective displays 211, in descending order relative to number of times played and/or number of users currently online in each Place. The user may then select subsequent pages out of the 2302 pages to display additional sets of Places in descending order.

In the example shown in FIG. 2 the user is viewing in descending order, Places most popular currently, beginning with the most popular (times played). To view pages of Places according to different criteria, the user may select for example “Top Favorites” from the Browse section of area 205, and “Past Day” from the Time section, causing display area 207 to show pages of Places each with display areas 211 showing information that may include number of times “favorited” (game rating) within the last 24 hours.

Any combination of Browse and Time selections may be made to display the game pages showing Places according to the chosen criteria. However in this example, regardless of whether the browsing user is registered to the system or not, or if registered, is a new or regular user, the places displayed in display area 207 are shown sorted in descending order according to the selection criteria for information associated with ALL registered users. For instance, in the first example described above the user has selected “Most Popular” and “Now” in menu display area 205, and is thereby shown in display 207, Places in best-to-worst descending order of total number of times played by all registered users and/or total number of all registered users currently online playing the game, regardless of the registered user's online behavior or characteristics (new user, regular user, user game genre preference, interaction with other users, etc.).

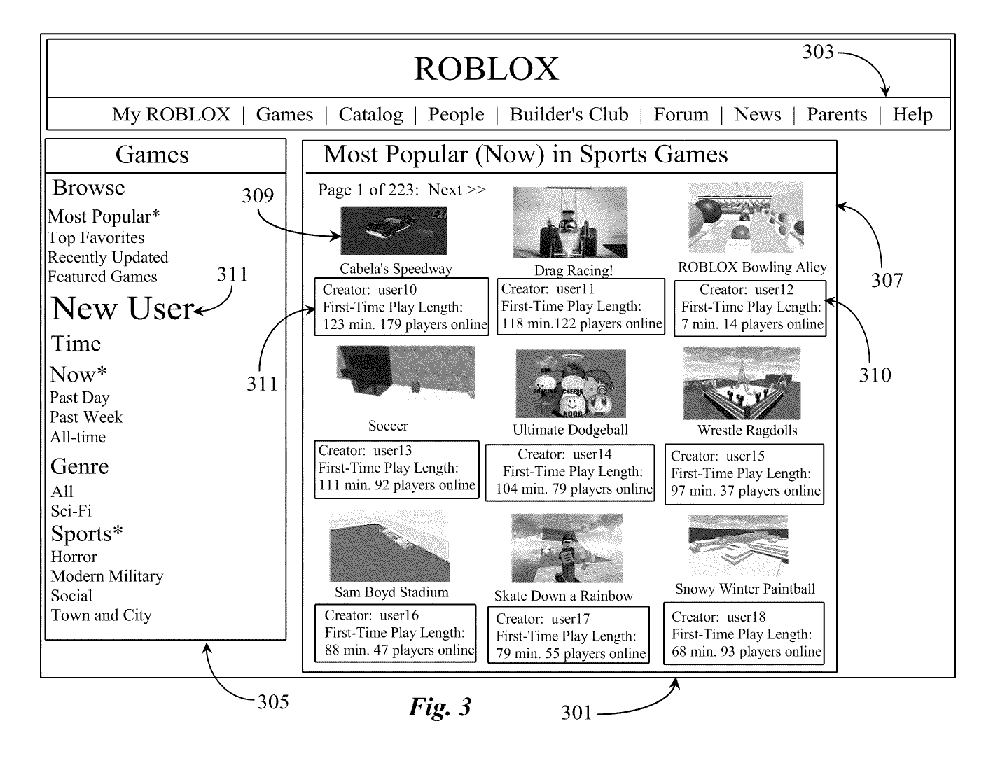

FIG. 3 is an illustration of a virtual reality Website game page according to an embodiment of the present invention. Website game page 301 is similar to game page 201 of FIG. 2 provided by server 105 and accessible to by a user of one of client stations 112 (1−n) of FIG. 1, including a tab bar 303, menu display area 305, game display area 307, a plurality of game links 309 each with a respective game information display area 311. As in Game links 209 of FIG. 2, game links 309 are URL links to Places offered by the system, and are illustrated as graphic representations of the Places displayed in a 2D grid such as illustrated in game display area 307, but in other embodiments links 309 may be displayed as textual links, as a set of 3D portals in a 3D world, or any other way without departing from the scope and spirit of the invention. All of the elements of game page 301 are in many ways similar in form and function to those of game page 201 of FIG. 2; therefore in the interest of avoiding redundancy detailed descriptions for each will not be given.

In the example given in FIG. 3 according to an embodiment of the present invention, assume an Internet user has entered the ROBLOX.com URL in a browser application and is thereby directed to a Website login page, whereby the user may enter a username/password if already registered to enter the Website, or if not registered, create a new user account. In the login page the registered user is presented with a tab bar 303 similar to that of FIG. 2, and the user in this example has selected the “Games” tab to browse games (Places). Games page 301 is thereby displayed in the user's browser application.

As mentioned in the background section of the present specification, users may be new to online gaming as a whole, or new to a particular gaming site and the particular games offered by that site. Many such new users are particularly interested in the games popular with other new users, as well as the early game-playing successes of, and post-play ratings by the other new users. If a new user has a preference for a particular game genre, such as “military battle” or “social” games, the new user is interested in similar games and the behaviors and activities of other users relative to such games.

Additionally, online game system administrators are interested in the user popularity of online games or “Places” offered by the system, particularly for new users. In order to attract and retain potential patrons of services offered by an online gaming system, it is desirable to offer new users browsing the gaming Website a proactive and user-friendly way to interactively enable new users of an online gaming site to quickly and easily browse virtual Places popular with other new users, and also to enable the user to view information pertaining to the Places' use, successes and ratings by other registered new users. System administrators are also interested in gathering new-user activity and characteristics information associated with particular Places that are popular with other new users, as well as gathering and storing such new user information associated with “experimental trial” virtual Places.

The system of the present invention, as further disclosed in enabling detail below, not only tracks and stores online gaming and other online activity for all registered users of the VR site, such as number of times particular Places have been played or number of times particular Places have been “favorited” by all users, but also tracks and stores user behavior and characteristics relative to the particular user, such as length of time a user has been registered as a client, which particular Places or genre of Places a user has played, length of time a user has visited particular Places, or successes of users in particular Places. Measurements are made of such user behavior to determine metrics for each user, and the metrics are tracked for the purpose of maintaining a database of such information for each Place offered by the system.

Referring back to FIG. 3, the user has logged into the Website by entering a username and password, and has selected the “Games” tab from tab bar 303 after logging in so as to browse Places offered by the system. Games page 301 is thereby displayed in the user's browser application. The system, by tracking the user's online behavior and based on the user id, recognizes the user as a “new user” i.e., a user whose account has been activated for less than X amount of days, for example. Games page 301 differentiates from Games page 201 of FIG. 2 in several ways, one of which in that a New User indication 306 is displayed in menu display area 305. By the system recognizing the registered user as a new user, upon the user logging in to the Website and choosing the “Games” tab to browse games, the user is automatically defaulted to Games page 301 which is optimized for the user based in part on the user's online behavior and characteristics, and in part on statistics regarding play of the same games by other new users, or even all other users. That is, the descending order of the game links presented is determined by the fact that the user who has logged in is a “new user”, and by the facts of play success of other new users, as tracked and recorded by the system. The goal is to engage the user as successfully as possible; to enhance the user's experience. The system is thus designed to know which games have been successfully engaged by other new users, and to present those games preferentially to the new user who has logged in.

As previously mentioned with reference to FIG. 2, additional categories, such as Genre for instance, may be included in the menu display area enabling a user to select all “military” games played the most times (Most Popular) over the past week, or “social” games most rated best (Top Favorites) for all-time. There are many possibilities. Menu display area 305 in this embodiment includes an exemplary menu selection list of such selectable choices entitled “Genre”

In a preferred embodiment of the invention as illustrated in FIG. 3, a new user as defined by the system, upon logging in at the login page and choosing “Games” from the Tab bar, is presented in display area 307 with a view of Places which is optimized to show the user Places sorted in descending order from best to worst according to current intelligence in the system regarding play success by other new users, for example first-time play length; that is, average length of time each Place has been visited by other new users of the system. In the example shown, the default view is indicated by “Most Popular” (longest first-time play length) and “Now” (current) highlighted in menu display area 305. Further, by the system either tracking the browsing user's online behavior history indicating frequent visits to sports-related Places, or characteristics based upon a user profile set up by the user specifying a preference for sports-related games, or both, the “Sports” genre is also automatically selected for the user as part of the Places selection criteria for display in area 307. The header “Most Popular (Now) in Sports Games” is thereby displayed in display area 307. The criteria of the sort are indicated by asterisk and bolding in the menu area, as shown for “Most Popular”, “Now” and “Sports”. This is defaulted for the new user inn this example by current system knowledge, but the other selections are interactive, so the logged-in user may change the sort criteria if he/she wishes.

So, generally speaking, sorts may depend on a variety of statistics and control. A different sort may be displayed to a user based in part on age of the user's account, how many times the user has played, how often the user logs in to play, how long since the user last logged in, the user's age category, and almost any other imaginable parameter that might prove to be advantageous.

System administrators are interested in gathering new-user activity and characteristics information associated with particular Places that are popular with new users, and also in gathering and storing such new user information associated with “experimental trial” virtual Places. In a preferred embodiment as illustrated in FIG. 3 the new user upon logging in and choosing the “Games” tab to browse games is defaulted to games page 301 presenting a view of Places which is optimized for the user as described above. In this embodiment display area 307 shows page 1 of “top ranked” Places based upon user behavior and characteristics, said Places represented by links 309. A link 310 is included along with links 309 in display area 307. Link 310 is similar to links 309, with the exception that by the user clicking on the link the user is taken to a random “experimental trial” Place. The system of the present invention, in order to gather user behavior information for ALL places, not just those presented according to user behavior or characteristics, includes such random Places as a percentage of the total Places viewed. The genre or other characteristics of the random Place may not necessarily be the same as the “top ranked” Places. For example random link 310 may represent a “Modern Military” or “Social” Place instead of the “Sports” genre of links 309, and so on. A percentage of random places such as that represented by link 310 may be included in each display of Places in display area 307, in this case 1 out of 9, or approximately 11 percent. For every new display of the Places for a user to visit, a ratio of highly ranked Places to experimental trial Places may be presented to the user. This ratio is variable depending on several factors.

It should be apparent to the skilled person that the embodiments described above are exemplary, and that many details may be altered without departing from the spirit and scope of the invention. For example, the windows may be rendered in a broad variety of ways. The links illustrated may also be rendered in different ways. The software that enables functionality may be coded in many different ways as well. Design of web sites is notoriously well known to be variant. The invention in its broadest aspects may be enabled and practiced in many different ways. The invention is defined by the scope of the claims that follow.

What is claimed is:

1. A method for presenting prioritized navigation links in an interactive display presented by an enterprise hosting a web site including places as destinations of the navigation links, comprising the steps of:
(a) identifying a person interacting with the interactive display, which is presented by software executing on a computerized appliance from a machine-readable medium;
(b) determining characteristics of the person's interactive behavior with the web site;
(c) determining characteristics of the places;
(d) comparing the characteristics of the places with the characteristics of the person's interactive behavior to determine a likely preference for places to the person; and
(d) presenting the navigation links in a descending order of preference in the interactive display to the person accessing the interactive display.

2. The method of claim 1 wherein the characteristics of the person's interactive behavior with the web site include stored data indicating length of time the person has been registered to the web site.

3. The method of claim 1 wherein the characteristics of places includes at least stored data regarding statistics of visits to the places by other registered members.

4. The method of claim 3 wherein the statistics of visits include one or more of frequency of visits, total number of visits, and time spent per visit.

5. The method of claim 1 wherein characteristics of the person's interactive behavior with the web site include data provided by the person in a stored profile, the data including preference for place characteristics.

6. The method of claim 1 wherein the web site is a virtual reality web site, and the places are virtual reality games.

7. A web site comprising:
software executing on a computerized appliance from a machine-readable medium, providing an interactive display; and
navigation links presented in the interactive display in a prioritized arrangement, the links to places in the web site;
wherein the software identifies a person interacting with the interactive display, determines characteristics of the person's interactive behavior with the web site, determines characteristics of the places, compares the characteristics of the places with the characteristics of the person's interactive behavior, determines a likely preference for places to the person, and presents the navigation links in the prioritized arrangement as a descending order of preference in the interactive display to the person accessing the interactive display.

8. The web site of claim 7 wherein the characteristics of the person's interactive behavior with the web site include stored data indicating length of time the person has been registered to the web site.

9. The web site of claim 7 wherein the characteristics of places includes at least stored data regarding statistics of visits to the places by other registered members.

10. The web site of claim 9 wherein the statistics of visits include one or more of frequency of visits, total number of visits, and time spent per visit.

11. The web site of claim 7 wherein characteristics of the person's interactive behavior with the web site include data provided by the person in a stored profile, the data including preference for place characteristics.

12. The web site of claim 7 wherein the web site is a virtual reality web site, and the places are virtual reality games.
